(19) United States
(12) Patent Application Publication
(10) Pub. No.: US 2006/0036457 A1
(43) Pub. Date: Feb. 16, 2006

(54) Systems and methods for facilitating romantic connections

(76) Inventor: Lori McNamara, Toronto (CA)

Correspondence Address: FITZPATRICK CELLA HARPER & SCINTO, 30 ROCKEFELLER PLAZA, NEW YORK, NY, 10112, US

(21) Appl. No.: 10/918,528

(22) Filed: Aug. 13, 2004

(51) Int. Cl. G06Q 99/00

(52) U.S. Cl. 705/1

(57) ABSTRACT

Methods, systems and computer-readable medium are provided for facilitating a romantic connection between a first entity and another entity. The first entity can communicate using a client computer to deliver to a server over a network profile data describing at least one aspect of the first entity that would be of romantic interest to a potential date. Profile data is stored at the server. The first entity is provided with a first set of physical items, the first set including at least one physical item, each physical item in the first set intended for distribution to another entity and bearing an access code that is affiliated at the server computer with the profile data of the first entity. A second entity who receives a physical item in the first set to communicate with the server using a client computer is enabled to retrieve the profile data of the first entity in response to providing to the server the access code borne on the physical item.

### BACKGROUND OF THE INVENTION

1. Field of the Invention

This invention relates to a system and methods for facilitating romantic connections, including systems and methods for meeting and managing potential dates. More particularly, the invention provides methods and means that enable an individual user to easily indicate interest in others whom they have met physically, and screen them in an effective and efficient manner, while maintaining a certain level of anonymity in the process.

2. Related Background Art

For many people, meeting others for the purposes of dating can be a stressful, unpleasant and often unsuccessful experience. Many people, for example, are too busy to devote the time necessary to meet potential dates. Others have the time, but are unskilled at engaging in the social intercourse necessary to make themselves appealing to another and/or at assessing whether another would be compatible with them. Still others are simply too shy to engage in such social intercourse.

For these reasons and others, numerous methods and systems for connecting individuals for dating purposes have been used or proposed. For example, so-called computer dating services have been in use since at least the 1970s. In such systems, participants typically fill-out questionnaires, prepared by those administering the system. Completed questionnaires are compared with completed questionnaires filled-out by other participants, in an effort to identify potential matches. Participants are notified of those with whom they match, and may then embark on one or a series of dates to determine whether there is true compatibility.

The emergence of the Internet has greatly expanded and enhanced the computer dating experience, and numerous companies have developed successful businesses around maintaining an Internet Web site that offers virtual meeting and matching features. Examples of such sites include www.match.com, www.lavalife.com and areas of www.yahoo.com, among others. While all of these sites differ in terms of their revenue models and certain other specifics, the essential experience at each is the same. Users register as members of the site and post profiles of themselves. The profiles might include a photograph, screen name, certain core physical statistics (e.g., sex, age, body type, hair color, eye color, etc.), certain core non-physical statistics (e.g., geographic location, religion, income, education, sexual orientation, number of children, etc.) and a written narrative prepared by the member. The profile might also provide core physical and non-physical statistics that that user requires or finds desirable in a mate. Members may search the posted profiles, in an effort to identify individuals whose postings they find interesting. Various search tools may be offered for this purpose.

For example, a searcher may be provided with tools necessary to search for the postings of females between age 30 and 35 who live within a 5 mile radius of downtown Chicago and have at least an undergraduate college degree. Searches of greater or lesser specifity may also be permitted. In any event, once the search terms are entered, the searching user is provided with a collection of all profiles meeting his criteria, which he may browse through at his leisure. The profiles would typically be provided with some mechanism for contacting the posters of profiles found to be of interest, such as by sending an e-mail message or the like. Significantly, the real name of the poster and certain other information (such as address, telephone number, etc.) are generally not included in the profile, so that some degree of anonymity is provided.

In addition to the search and browse capabilities described above, these Web sites often may offer matching features. Through these features, the profiles of the users that have been posted may be compared to automatically determined potential matches. Matchees may then be advised by the system of those with whom they have matched, so that they may study the profiles of their matches and contact them if desired.

The prior art methods described above offer useful mechanisms for facilitating the process of meeting people, by providing a large amount of useful information about a potential date and a convenient way of contacting a potential date when a profile appears interesting. However, they all suffer from the same fundamental drawback. Specifically, in all of these prior art techniques, the classical way in which a romantic connection occurs—by the two people seeing one another physically and generating an attraction—is reversed, such that a physical meeting does not occur until later in the process. The present inventor believes that this is a fatal flaw that severely limits the effectiveness of the prior art techniques discussed above.

Some methods and systems have attempted to solve that problem. U.S. Pat. No. 6,269,732 describes a match-making system called PLATEDATE, which enables an individual to request a date from a driver of a vehicle that he or she sees, by inputting into the PLATEDATE database the vehicle's license plate number. But PLATEDATE suffers from significant drawbacks. Most notably, for the request for a date to be communicated, the owner of the vehicle must have himself/herself registered with the PLATEDATE system. If he/she did not, then the request could not possibly be communicated. Also, even if the vehicle owner were registered, there would of course be no guarantee that the spotted driver were in fact the owner. Thus, one could be requesting a date from a person different from the one spotted.

PCT Publication WO 01/37232 purports to provide a matchmaking service to match two people who have already seen each other. In that system, which styles itself WholovesWho.com, registered users designate to the system Web site the name(s) and profile(s) of so-called Love Person(s), in whom the user has interest. If such a Love Person has themselves designated that user as a Love Person as well, a match is made and both persons are informed or, an anonymous e-mail can be sent from the designating person to the Love Person. However, as in the case of PLATEDATE, a fundamental limitation of WholovesWho.com is that it can only match two people who are already registered. It provides no mechanism whatsoever for matching a registered and unregistered person.

There is a need, therefore, for a system and method that takes an entirely fresh approach, and harnesses the powers of network computers to provide a mechanism that facilitates romantic connections between two people who have already met physically, whether or not both of them have already registered with a service provider.

### SUMMARY OF THE INVENTION

In accordance with one embodiment of the present invention there is provided a method for facilitating a romantic connection between a first entity and another entity. The method includes maintaining on a network a server with which the first entity can communicate using a client computer to deliver to the server over the network profile data describing at least one aspect of the first entity that would be of romantic interest to a potential date. The method also includes storing the profile data at the server and providing the first entity with a first set of physical items, the first set comprising at least one physical item, each physical item in the first set intended for distribution to another entity and bearing an access code that is affiliated at the server computer with the profile data of the first entity. The method also includes enabling a second entity who receives a physical item in the first set to communicate with the server using a client computer to retrieve the profile data of the first entity in response to providing to the server the access code borne on the physical item.

In accordance with another embodiment of the present invention there is provided a server on a network adapted to facilitate a romantic connection between a first entity and another entity. The server includes means for receiving from a first entity using a client computer over the network profile data describing at least one aspect of the first entity that would be of romantic interest to a potential date; means for storing the profile data at the server. The server also includes means for enabling a second entity using a client computer to communicate with the server to retrieve the profile data of the first entity in response to providing to the server an access code borne on a physical item, the physical item having been given to the second entity by the first entity, the access code having been affiliated at the server computer with the profile data of the first entity.

In accordance with yet another embodiment of the present invention there is provided a computer-readable medium containing code for facilitating a romantic connection between a first entity and another entity. The computer-readable medium includes code for receiving from a first entity using a client computer over the network profile data describing at least one aspect of the first entity that would be of romantic interest to a potential date. The medium also includes code for storing the profile data at a server. The medium further includes code for enabling a second entity using a client computer to communicate with the server to retrieve the profile data of the first entity in response to providing to the server an access code borne on a physical item, the physical item having been given to the second entity by the first entity, the access code having been affiliated at the server computer with the profile data of the first entity.

In accordance with another embodiment of the present invention there is provided a method for facilitating a romantic connection between a first entity and a second entity including maintaining a server on a network. The method also includes providing the first entity with a first set of physical items, the first set comprising at least one physical item, each physical item in the first set intended for distribution to another entity and bearing an access code. The method further includes, in response to receiving from a second entity who has been given a physical item in the first set the access code borne on the physical item, enabling the second entity to provide to the server a message for the first entity. The method also includes, at the server, associating the message for the first entity with the access code and in response to receiving the access code from the first entity, providing the first entity with the message for the first entity.

In accordance with another embodiment of the present invention there is provided a server on a network for facilitating a romantic connection between a first entity and a second entity. The server includes means for enabling the second entity to provide to the server a message for the first entity, in response to receiving from the second entity an access code borne on a physical item that was given to the second entity by the first entity and means for associating the message for the first entity with the access code. The server also includes means for providing the first entity with the message for the first entity, in response to receiving the access code from the first entity.

In accordance with yet another embodiment, the present invention provides a physical item intended for distribution to a recipient by a first entity for the purpose of expressing a romantic interest. The physical item bears an access code, the access code being usable by the recipient to retrieve from a server on a network profile data provided to the server by the first entity. The profile data describes at least one aspect of the first entity that would be of interest to a potential romantic date.

Another embodiment of the present invention provides a computer-readable medium containing code for facilitating a romantic connection between a first entity and a second entity. The computer-readable medium includes code for enabling the second entity to provide to a server a message for the first entity, in response to receiving from the second entity an access code borne on a physical item that was given to the second entity by the first entity. The medium further includes code for associating the message for the first entity with the access code, and for providing the first entity with the message for the first entity, in response to receiving the access code from the first entity.

### BRIEF DESCRIPTION OF THE DRAWINGS

FIG. 1 illustrates an exemplary environment in which the present invention may be carried out.

FIG. 2 shows an example of an Attraction Ticket.

FIG. 3 shows an example of a Web page provided to a client computer upon initial connection to a Web site.

FIG. 4 shows an example of a Web page that may be used to access a Member profile using the login code provided on an Attraction Ticket.

FIG. 5 shows an example of a Web page that provides a Member profile.

### DETAILED DESCRIPTION OF THE PREFERRED EMBODIMENTS

As used herein, “computer” may refer to a single computer or to a system of interacting computers. Generally speaking, a computer is a combination of a hardware system, a software operating system and perhaps one or more software application programs. Examples of computers include, without limitation, IBM-type personal computers (PCs) having an operating system such as DOC, Windows, OX/2 or Linux; Macintosh computers; hardware having a JAVA-OS operating system; graphical work stations, such as Sun Microsystems and Silicon Graphics Workstations having a UNIX operating system; PalmPilots; and PilotPCs.

“Network” means a connection between any two or more computers, which permits the transmission of data. An example of a network is the Internet.

“Web page” means any documents written in mark-up language including, but not limited to, HTML, (hypertext mark-up language) or VRML (virtual reality modeling language), dynamic HTML, XML (extended mark-up language) or related computer languages thereof, as well as to any collection of such documents reachable through one specific Internet address or at one specific Web site, or any document obtainable through a particular URL (Uniform Resource Locator).

“Web site” means at least one Web page, and preferably a plurality of Web pages on Web sites. Examples of Web browsers include, without limitation, Netscape Navigator and Microsoft Internet Explorer.

The phrase “display a Web page” include all actions necessary to render at least a portion of the information on the Web page available to the computer user. As such, the phrase includes, but is not limited to, the static visual display of static graphical information, the audible production of audio information, the animated visual display of animation and the visual display of video stream data.

A “server computer” or “server” is a computer or other electronic device capable of serving at least one page of data to another computer on its network. A “Web server” is a computer or other electronic device which is a capable of serving at least one Web page to another computer running a Web browser. A “client computer” or “client” is a computer running a Web browser.

For implementing aspects of the present invention, a software application could be written in substantially any suitable programming language, which could easily be selected by one of ordinary skill in the art. The programming language chosen should be compatible with the computer by which the software application is executed, and in particular with the operating system of that computer. Examples of suitable programming languages include, but are not limited to, C, C++, CGI, Java and Java scripts. Furthermore, certain functions of the present invention, when described as a series of steps for a method, could be implemented as a series of software instructions for being operated by a data processor, such that the present invention could be implemented as software, firmware or hardware, or a combination thereof.

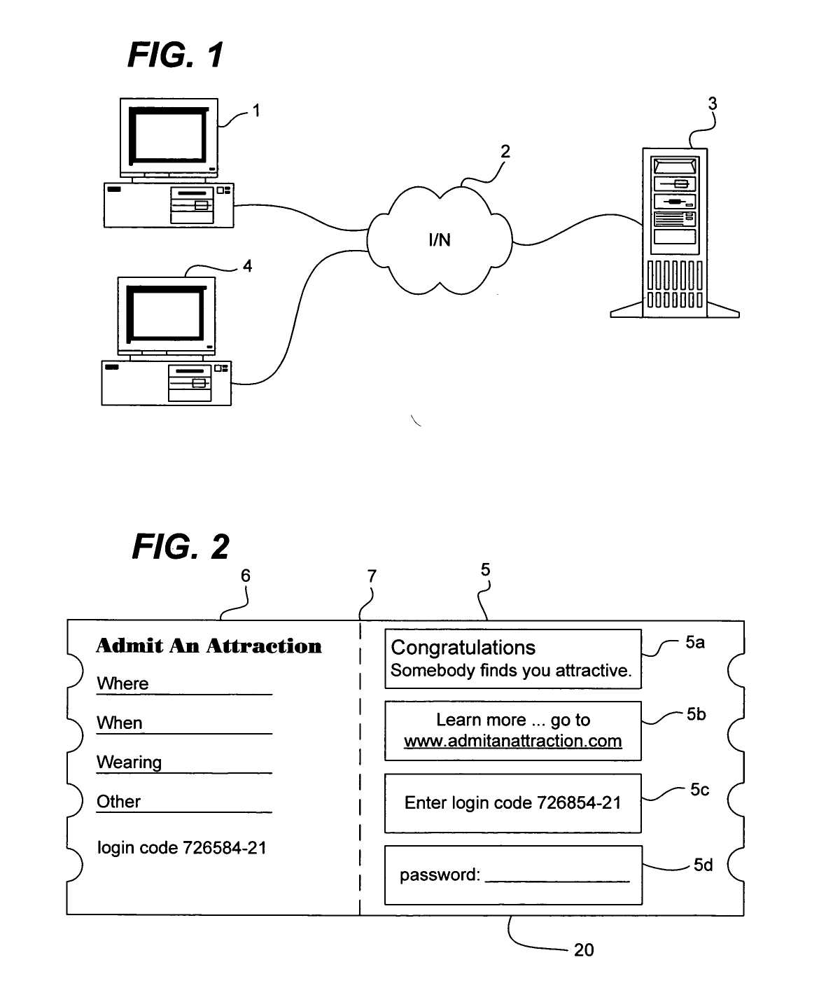

In a preferred embodiment of the present invention, a first user desiring to meet people for the purposes of dating registers with a Web site, in a conventional fashion. For example, as illustrated in FIG. 1, the first user may communicate via a computer 1, functioning as a client computer, over the Internet 2 with a Web site maintained on a Web server 3. Preferably, the first user (hereinafter referred to as a Member) would register by providing the server information such as a name, physical address, e-mail address, chosen screen name, certain physical and non-physical characteristics (e.g, sex, hair color, eye color, body type, sexual orientation, religion, education, among others) of himself (or herself) and physical and non-physical characteristics that he (or she) would require or find desirable in a mate. A digital photograph may also be provided. The Member would also typically specify a Member password and may additionally specify a Ticket password, which would be used in a fashion described below. In any case, some of the information provided by the Member would be included in a posted profile which would be available to others, while other parts of it, such as the real name and physical address of the Member, might be withheld, to provide a higher degree of security. Registration may be for free, or may alternatively be for a fee, such as a one-time fee or a recurring (such as monthly) fee. The entire Member profile is stored in a database associated with Web server 3.

The present invention uses a physical item, such as for example and without limitation a ticket, card, piece of paper, token, bauble, novelty item, pen, key chain, etc., as a means of enabling a Member to direct another person, as to whom the Member is physically attracted, to a networked computer, at which the other person can learn more about the Member and/or initiate a dialogue with the Member. For ease of reference, these physical items will be referred to herein as Attraction Tickets. It should be understood, however, that this term is being used for ease of reference only, and not to convey in any way that the physical item must be an actual ticket.

Following registration, the Member would be provided with a number of Attraction Tickets. In one embodiment, the Attraction Tickets are provided in the form of booklet, so that they may be torn out and distributed, as will be described in greater detail below. Attraction Tickets may be provided free of charge, or alternatively for a fee. In one preferred embodiment, a first set of Attraction Tickets (such as for example a book of ten tickets) are provided for free, while subsequent tickets are provided either for a fee or in exchange for credits, which may be accumulated in the fashion described below. In another preferred embodiment, a single initial Attraction Ticket is provided for free, and booklets are then available for purchase. Attraction Tickets could be purchased from the Web site, or from retail outlets. Attraction Tickets could also be distributed for free or sold in connection with marketing or promotional activities.

An example of Attraction Ticket 5 is shown in FIG. 2. Each Attraction Ticket may include a corresponding stub 6 intended to be retained. Most preferably, the Attraction Ticket 5 and stub 6 are separated by a perforation 7, so that the Attraction Ticket 5 can be easily detached for distribution, while the stub 6 remains secured in the book.

In accordance with the present invention, each Attraction Ticket 5 is intended to be distributed by the Member to individuals whom the Member physically meets and finds attractive (herein after referred to as a “Recipient”). The term “meets” is being used here in its broadest sense, and encompasses any situation in which the Member physically sees a Recipient and has an opportunity to provide that Recipient with an Attraction Ticket. Some examples of such meetings include without limitation the following:

A (the Member) meets B at a party, and speaks with her for several hours. They hit it off very well. At the end of the party, A hands B an Attraction Ticket, and says goodbye.

C (the Member) is in front of D in line at a supermarket. C thinks D is handsome, and flirtatiously tells him that she likes his shirt. D thanks C, but is too shy to continue the conversation. After buying her groceries, C smiles, hands D an Attraction Ticket and walks away.

E (the Member) is walking his dog, and sees F coming towards him. He does not know F, but is attracted to his tall physique and blonde hair. As they pass, E hands F an Attraction Ticket.

G (the Member) and H knew each other in college, but have not seen one another in almost ten years, although they have always been attracted to one another. One night, H is walking out of a bar and G is walking in. They say hello, but are both with friends and there is no opportunity for a real conversation. G hands H an Attraction Ticket as they say goodbye.

I (the Member) is at a nightclub. He meets multiple woman J, K, L, M, N, O and P and talks to each individually for ten or fifteen minutes, after which he hands each of them an Attraction Ticket, so that by the end of the party, he has distributed multiple Tickets.

Of course, the scenarios described above are exemplary only and a myriad of other possibilities exist as well.

The Attraction Ticket 5 typically includes a brief explanation of purpose 5a, and an invitation 5b to the Recipient to visit a Web site to learn more about the person who gave the Attraction Ticket to them. Towards this end, the Attraction Ticket is provided with an access code, in this example a login code 5c, and may optionally and additionally be provided with a field 5d in which a Ticket password may be entered. The Ticket password would be recorded by hand by the Member, before giving the Attraction Ticket to the Recipient, to add a further level of security to the system. Those skilled in the art will readily appreciate that other security measures are possible as well.

The stub 6 includes various space in which the Member may record certain information, such as where the Member distributed the Attraction Ticket, when the Attraction Ticket was distributed, what the Recipient was wearing, and other information that might help the Member recall to whom the Attraction Ticket was given. Such information could include the recipient's hair color, eye color, skin color, etc., or even the Recipient's name, if it is or was made known to the Member. The stub 6 also includes a pre-printed login code that corresponds precisely to the login code pre-pointed on the Ticket 5. Preferably, the login code on each Ticket/stub pair is unique, allowing the Member to learn which Recipients to whom Tickets were given actually visited the Web site. Most preferably, each unique login code consists of two parts: a first part that is the same on every Ticket/stub pair issued to a given Member (the “726854” in the example of FIG. 2) and a second part that is unique to each Ticket/stubs issued to give Member (the “21” in the FIG. 2 example) making the combination of the two unique across all Tickets and all Members.

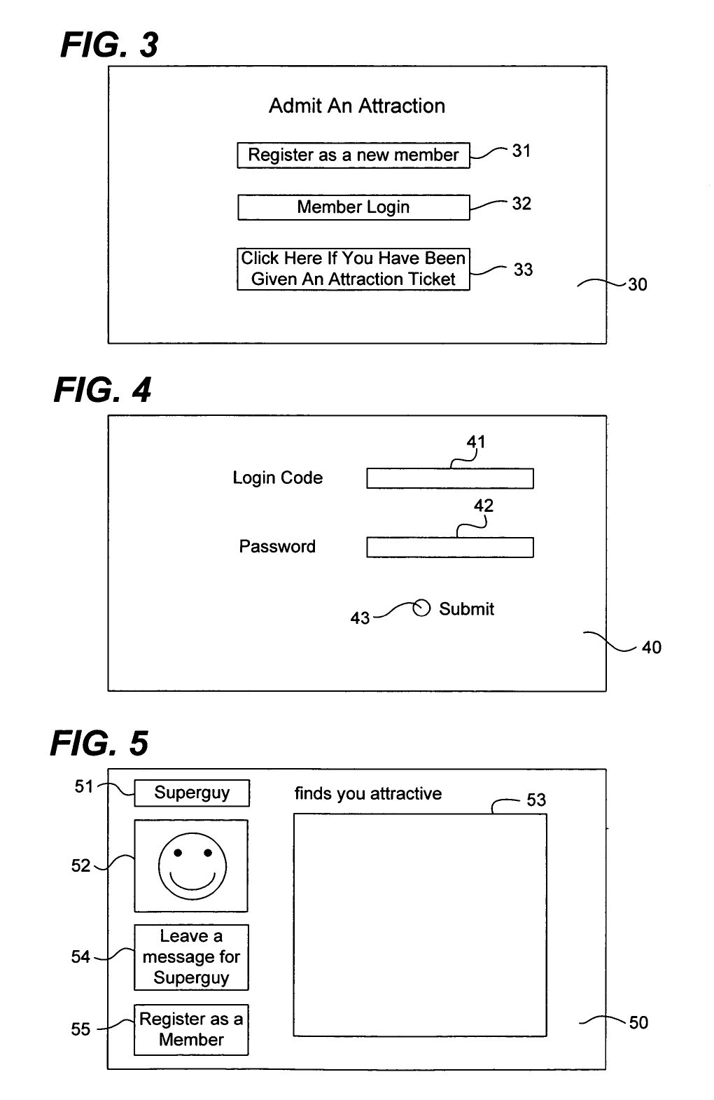

A Recipient utilizes his/her own computer 4, functioning as a client computer, to connect to the server 3 to visit the Web site to which the Ticket directs him/her (in this example, www.admitanattraction.com). A Web page along the lines of the Web page 30 depicted in FIG. 3 is displayed. That Web page would include a button 31 for registering as a new Member, a button 32 for existing Member login and a button 33 which can be used by a Recipient to enter the site. In most cases, the Recipient would not be a Member. Upon clicking button 33, Web page 40 is displayed. This page 40 includes a field 41 into which the recipient enters the login code printed on the Attraction Ticket he has be given, and an optional field 42 into which the recipient enters the password on the Ticket. Upon clicking the submit button 43, the entered information is provided to the Web server 3.

Web server 3, upon receiving the entered information, searches its databases and retrieves the Member profile that corresponds to that login code. If none is found, then the Web server 3 determines that the login code is invalid, and an error message (“Invalid Login Code”) is returned. In the case where a password is also required, the Web server will also compare the entered password in the Member profile, to ensure a match. If the two password do not match, then an error message (“Invalid Password”) is returned. In this fashion, the Ticket password feature prevents someone who was not given an Attraction Ticket but, say, simply finds an Attraction Ticket that has been lost, from accessing the system. It should be noted that the Ticket password is different from the conventional Member password, which the Member uses to enable such actions as checking his/her mail, editing his/her profile, etc., and which the Member would generally keep secret.

Attraction Tickets may be made to have an expiration date, after which they are no longer valid. Alternatively, they may be made to have no expiration date.

In any case, if the login code and password are deemed valid, a Web page along the lines of Web page 50 in FIG. 5 is displayed. This page provides the chosen screen name 51 of the Member who gave the Ticket to the Recipient, a photograph 52 of the Member, and a field 53 which displays information about the Member entered by the Member at registration. The Web page 50 also includes a button 54 which enables the recipient to leave a message for the Member, and a button 55 which enables the recipient to register as a Member him/herself.

The Recipient's visiting of the Web site using the login code and retrieval of the Member's profile is noted by the server 3, and may be reported to the Member through a system generated message, which the Member may read the next time he/she logins in. An e-mail to an outside address of the Member, indicating the occurrence of a Recipient's visit, may also be sent. The fact that a specific Recipient visited the site through the use of an Attraction Ticket may be reported to the Member even when the Recipient does not send a message to the Member, by reporting to the Member that a unique login code has been used. The Member may then correspond that login code with a specific stub 6, and remind him/herself who the Recipient was through the information about the Recipient that was recorded. Preferably, the server 3 provides the Member with a list of all Recipients who visited the site using a login code provided on one of the Member's Tickets, and the time and dates of such visits, each time the Member logs-in.

In a case where a Recipient does leave a message for the Member, it may be provided to the Member via an e-mail, in the same general fashion that a member of a conventional dating site may leave a message for another member. The message itself could be a written narrative prepared be the Recipient, and in such a case could provide as much or as little information about the Recipient and as to how the Member can get back in touch with the Recipient as the Recipient desires. For example, the Recipient could include in his message a real name, a telephone number, an e-mail address, a mailing address, or even no contact information at all. The Member may be made to respond to the Recipient through the site, as long as the Recipient effected at least a mini-registration using the login code, in the manner described below. The allowable messaging between the Member and the Recipient may be made to be unlimited.

In an alternate embodiment, before leaving a message for the Member, the Recipient is prompted with certain questions. These questions might include questions concerning the circumstances under which the Recipient received the Ticket (e.g. Where were you given the Ticket?; What were you wearing when you were given the Ticket?; etc.). The site could even suggest to the Recipient that he choose a screen name related to those circumstances. This information could then be provided to the Member, to help the Member recall the identity of the specific Recipient. Such information would be particularly helpful in a circumstance where the Member did not or was unable to record information about the Recipient on the Ticket's corresponding stub (such as, for example, in a crowded nightclub); or when the present invention is implemented using an Attraction Ticket that does not include a stub.

In another alternative embodiment, the Recipient who uses the login code on a Ticket is not provided with the Member's profile at all, but simply is provided with a means of leaving a message for the Member. This embodiment would provide an enhanced level of anonymity to the Member. The site could even be constructed so that it generally will provide a Member profile when a Ticket login code is used, but allows Members to disable that feature, and only enable the Recipient to leave a message when their specific Attraction Tickets are used.

Another variation, which may be used in conjunction with or as an alternative to the Ticket password feature described above, is to configure the Web site to ask the Recipient a security-type question before providing the Member's profile or enabling the Recipient to leave a message. Such question might be, for example “What color hair did the person who gave you the Ticket have?” or “Was the Ticket given to you by a man or a woman?” The server, which would of course have been provided with the answer to the question in connection with the establishing of the Member's profile or through some other means, would only allow the Recipient to proceed when the answer given is correct. This feature, like the Ticket password feature, would reduce the chances of individuals who were not given an Attraction Ticket, but instead simply found one or were attempting a sabotage, from accessing the system.

An extremely advantageous feature of the present invention is that it can serve as a mechanism for attracting new Members to the Web site. In particular, the Recipient could also register as a Member himself, and in that case might also or instead direct the Member who gave him the Ticket to his profile as a means of learning more about the Recipient and of responding to the Recipient's message. By registering as a Member and directing the first Member to his profile, the Recipient/new Member is able to provide the first Member with a means of response, while at the same time maintaining the same level of anonymity being enjoyed by the first Member, or by any Member of a conventional dating Web site. In the case where the Recipient does register as a Member, the server 3 will preferably embed in the Recipient's message a link to the Recipient's profile, so that it may be retrieved by the first Member readily and in a convenient fashion.

It should be readily appreciated that the entity which maintains the Web site will generally want to attract as many new Members as possible. Towards that end, the Web site may alternately be configured such that the Recipient is not permitted to leave a message for the Member who gave him the Ticket, unless the Recipient first registers as a Member himself. Alternatively, the site could be configured such that while full registration as a Member is not required to leave message, the provision of certain core-type information, such as a name, e-mail address, etc., is required.

Incentives for joining as a Member might be offered to those who have been drawn to the site through an Attraction Ticket. Such incentives might take the form of, among other things, a reduced membership fee, or a discount on the purchase of their own Attraction Tickets.

The migration of a Recipient into a new Member provides considerable advantages for the entity maintaining the Web site and the community that participates with the site as a whole. Consider the following example, which illustrates how the use of Attraction Tickets might proliferate:

Q is eating at restaurant and leaves an Attraction Ticket for R, the waitress. R goes online and responds to Q by creating a profile, registering as a Member and leaving a message for Q. She takes advantage of the discount she receives on the purchase of her own Attraction Tickets for being the recipient of an Attraction Ticket. Q logs on to find out if R has responded. R has, but her profile mentions that she is 22. Because Q is 42, and was hoping to date a woman at least 30, he deletes her and orders more Attraction Tickets. R and her friends go out to a nightclub. R gives an Attraction Ticket to S, a man she meets while buying a drink at the bar. S is not interested in R, but he logs on to the Web site where he registers and buys his own Attraction Tickets, taking advantage of the discount. The following week, S spots T, a nice looking woman, sitting near the back door of the streetcar he is riding. As he exits the streetcar, he passes her an Attraction Ticket.

In one advantageous embodiment of the present invention, a Member who posts a profile may designate that her profile not be made available in any way other than through the login code on her Attraction Ticket. In such a case, her profile would not be returned, for example, when a conventional search of profiles was performed or when conventional matching features were used. With this implementation, potential members who wish to enjoy the benefits of the community but who are apprehensive of having their profile made publically available may participate in the site, allowing only those people to whom they give an Attraction Ticket to retrieve their profile.

It is also possible to structure the site such that even someone who has not joined as a Member may use an Attraction Ticket. For example, Attraction Tickets bearing unique codes could be distributed to attendees of a public event, such as for example a concert. A first concert attendee who is given a Ticket, and who is a non-member, might then give her Ticket to a second attendee, also a non-member, who she finds attractive. If the first attendee registers as a Member before the second attendee visited the site, and as part of the registration process provided the login code of the Attraction Ticket she was given and subsequently gave to the second concert goer, then her profile would be associated with that login code. In that case, when the Recipient of her Ticket (that is, the second concert goer) came to the site using the login code, he could be provided with her profile in the manner described above. On the other hand, if the Recipient came to the site using the login code before the first concert goer became a Member, he could not be provided with her profile, but instead would only be provided with a means to leave the first concert goer a message. That message could be retrieved by the first concert goer when she registers as a Member, or otherwise came to the site, using the login code.

In fact, the site could be constructed so that a Recipient and the person who gave the Ticket to the Recipient can communicate repeatedly, and in an anonymous fashion, even though neither of them has registered as a Member. In such a case, each would be required to effect a mini-registration. In the min-registration, each would provide for example, a screen name and perhaps a selected password, but they would not need to be required to effect a full Membership registration or submit a profile. The mini-registration process for each of them in that case would need to include providing the login code on the Ticket, so that their accounts could be associated with the code so that their messages can be effectively exchanged. The mini-registration process would also preferably include identifying oneself as the giver or receiver of the Attraction Ticket. Once the mini-registrations were complete, the messaging between the two could be made to be unlimited.

Optionally, bonus credits may be issued to a Member who distributes a Ticket that draws a Recipient to the Web site. Such credits may be issued to the Member when, for example, a login number is used to obtained the Member's profile, and the Recipient registers himself or herself as a new Member. Such bonus credits may be redeemable for additional Attraction Tickets, or for other purposes, such as goods, services, discounts, etc.

The present invention has been described with respect to issuing Tickets to facilitate romantic connections, and has been described in detail above through the use of multiple examples. These examples are meant to be illustrative only, and not restrictive in any way. It will be readily appreciated that the system and techniques of the present invention have applications in fields outside the field of dating and romantic connections, and may be utilized in those fields with equal effectiveness. And more generally, those skilled in the art will readily appreciate that numerous modifications of the examples set forth above may be made, without departing from the spirit and scope of the invention.

What is claimed is:

1. A method for facilitating a romantic connection between a first entity and another entity, comprising:
maintaining on a network a server with which the first entity can communicate using a client computer to deliver to the server over the network profile data describing at least one aspect of the first entity that would be of romantic interest to a potential date;
storing the profile data at the server;
providing the first entity with a first set of physical items, the first set comprising at least one physical item, each physical item in the first set intended for distribution to another entity and bearing an access code that is affiliated at the server computer with the profile data of the first entity; and
enabling a second entity who receives a physical item in the first set to communicate with the server using a client computer to retrieve the profile data of the first entity in response to providing to the server the access code borne on the physical item.

2. The method according to claim 1, further comprising the step of:
enabling the second entity to communicate with the first entity via the server by accepting a message from the second entity and delivering the message to the first entity via the network.

3. The method according to claim 1, further comprising the step of:
restricting access to the profile data of the first entity to only those entities who have been given one of the physical items in the first set by the first entity, by enabling a client computer to retrieve the profile data of the first entity only in response to the client computer providing the server with an access code borne on one of the physical items in the first set.

4. The method according to claim 3, wherein a client computer is enabled to retrieve the profile data of the first entity only in response to providing to the server the access code borne on a physical item in the first set and in further response to providing to the server a characteristic of the first entity, the characteristic having been provided to the server by the first entity.

5. The method according to claim 1, further comprising the step of:
enabling the second entity to provide to the server from a client computer via the network profile data describing at least one aspect of the second entity that would be of interest to a potential romantic date;
storing the profile data of the second entity at the server;
providing the second entity with a second set of physical items, the second set comprising at least one physical item, each physical item in the second set intended for distribution to another entity and bearing an access code that is affiliated at the server with the profile data of the second entity; and
enabling a recipient of a physical item in the second set to communicate with the server computer using a client computer to retrieve the profile data of the second entity in response to providing to the server the access code borne on the physical item.

6. A server on a network, adapted to facilitate a romantic connection between a first entity and another entity, comprising:
means for receiving from a first entity using a client computer over the network profile data describing at least one aspect of the first entity that would be of romantic interest to a potential date;
means for storing the profile data at the server; and
means for enabling a second entity using a client computer to communicate with the server to retrieve the profile data of the first entity in response to providing to the server an access code borne on a physical item, the physical item having been given to the second entity by the first entity, the access code having been affiliated at the server computer with the profile data of the first entity.

7. The server according to claim 6, further comprising:
means for enabling the second entity to communicate with the first entity via the server by accepting a message from the second entity and delivering the message to the first entity via the network.

8. The server according to claim 6, further comprising:
means for restricting access to the profile data of the first entity to only those entities who have been given a physical item that bears an access code, by enabling a client computer to retrieve the profile data of the first entity only in response to the client computer providing the server with an access code borne on a physical item.

9. The server according to claim 8, wherein a client computer is enabled to retrieve the profile data of the first entity only in response to providing to the server the access code borne on a physical item and in further response to providing to the server a characteristic of the first entity, the characteristic having been provided to the server by the first entity.

10. The server according to claim 9, further comprising:
means for receiving from the second entity using a client computer over the network profile data describing at least one aspect of the second entity that would be of romantic interest to a potential date;
means for storing the profile data of the second entity at the server; and
means for enabling a third entity using a client computer to communicate with the server to retrieve the profile data of the second entity in response to providing to the server an access code borne on a physical item, the physical item having been given to the third entity by the second entity, the access code having been affiliated at the server computer with the profile data of the second entity.

11. Computer-readable medium containing code for facilitating a romantic connection between a first entity and another entity, comprising:
code for receiving from a first entity using a client computer over the network profile data describing at least one aspect of the first entity that would be of romantic interest to a potential date;
code for storing the profile data at a server; and
code for enabling a second entity using a client computer to communicate with the server to retrieve the profile data of the first entity in response to providing to the server an access code borne on a physical item, the physical item having been given to the second entity by the first entity, the access code having been affiliated at the server computer with the profile data of the first entity.

12. Computer-readable medium containing code according to claim 11, said code further including:
code for enabling the second entity to communicate with the first entity via the server by accepting a message from the second entity and delivering the message to the first entity via the network.

13. Computer-readable medium containing code according to claim 11, said code further including:
code for restricting access to the profile data of the first entity to only those entities who have been given a physical item that bears an access code, by enabling a client computer to retrieve the profile data of the first entity only in response to the client computer providing the server with an access code borne on a physical item.

14. Computer-readable medium containing code according to claim 13, said code further including:
code for retrieving the profile data of the first entity only in response to providing to the server the access code borne on a physical item and in further response to providing to the server a characteristic of the first entity, the characteristic having been provided to the server by the first entity.

15. Computer-readable medium containing code according to claim 14, said code further including:
code for receiving from the second entity using a client computer over the network profile data describing at least one aspect of the second entity that would be of romantic interest to a potential date;
code for storing the profile data of the second entity at the server; and
code for enabling a third entity using a client computer to communicate with the server to retrieve the profile data of the second entity in response to providing to the server an access code borne on a physical item, the physical item having been given to the third entity by the second entity, the access code having been affiliated at the server computer with the profile data of the second entity.

16. A method for facilitating a romantic connection between a first entity and a second entity, comprising:
maintaining a server on a network;
providing the first entity with a first set of physical items, the first set comprising at least one physical item, each physical item in the first set intended for distribution to another entity and bearing an access code;
in response to receiving from a second entity who has been given a physical item in the first set the access code borne on the physical item, enabling the second entity to provide to the server a message for the first entity;
at the server, associating the message for the first entity with the access code; and
in response to receiving the access code from the first entity, providing the first entity with the message for the first entity.

17. The method according to claim 16, further comprising:
in response to receiving the access code from the first entity, enabling the first entity to provide to the server a message for the second entity; and
in response to receiving the access code form the second entity, providing the second entity with the message for the second entity.

18. A server on a network for facilitating a romantic connection between a first entity and a second entity, comprising:
means for enabling the second entity to provide to the server a message for the first entity, in response to receiving from the second entity an access code borne on a physical item that was given to the second entity by the first entity;
means for associating the message for the first entity with the access code; and
means for providing the first entity with the message for the first entity, in response to receiving the access code from the first entity.

19. The server according to claim 18, further comprising:
means for enabling the first entity to provide to the server a message for the second entity, in response to receiving the access code from the first entity; and
means for providing the second entity with the message for the second entity, in response to receiving the access code from the second entity.

20. A physical item intended for distribution to a recipient by a first entity for the purpose of expressing a romantic interest, the physical item bearing an access code, the access code being usable by the recipient to retrieve from a server on a network profile data provided to the server by the first entity, the profile data describing at least one aspect of the first entity that would be of interest to a potential romantic date.

21. Computer-readable medium containing code for facilitating a romantic connection between a first entity and a second entity, comprising:
code for enabling the second entity to provide to a server a message for the first entity, in response to receiving from the second entity an access code borne on a physical item that was given to the second entity by the first entity;
code for associating the message for the first entity with the access code; and
code for providing the first entity with the message for the first entity, in response to receiving the access code from the first entity.

22. Computer-readable medium containing code according to claim 21, said code further including:
code for enabling the first entity to provide to the server a message for the second entity, in response to receiving the access code from the first entity; and
code for providing the second entity with the message for the second entity, in response to receiving the access code from the second entity.
